(19) United States
(12) Patent Application Publication
(10) Pub. No.: US 2026/0104860 A1
(43) Pub. Date: Apr. 16, 2026

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Tokyo (JP)

(72) Inventor: Shohei MITANI, Tokyo (JP)

(73) Assignee: NEC Corporation, Tokyo (JP)

(21) Appl. No.: 19/344,855

(22) Filed: Sep. 30, 2025

(30) Foreign Application Priority Data
Oct. 10, 2024 (JP) 2024-178478

(51) Int. Cl. G06F 8/20; G06F 8/77

(52) U.S. Cl. CPC G06F 8/20; G06F 8/77

(57) ABSTRACT

An information processing apparatus includes an acquisition means and a satisfaction determination means. The acquisition means acquires at least information related to requirements for a system or restrictions on the system from a database that stores information related to the system. The satisfaction determination means determines, based on the acquired information related to requirements for the system or restrictions on the system, whether or not information necessary for execution of one design task among a plurality of design tasks in a phased design flow of the system is included in design information of the one design task.

### INCORPORATION BY REFERENCE

This application is based upon and claims the benefit of priority from Japanese Patent Application No. 2024-178478, filed on October 10, 2024, the disclosure of which is incorporated herein in its entirety by reference.

### TECHNICAL FIELD

The present disclosure relates to an information processing apparatus, an information processing method, and a non-transitory computer-readable storage medium.

### BACKGROUND ART

In a system development project, risk management plays an important role in ensuring success of the project.

As a method of project risk evaluation, a method of aggregating evaluation values of people based on development documents or the like is sometimes used (see, for example, Patent Literature 1 (JP2022-180289 A)).

In addition, in a field of text quality analysis, a method of evaluating quality of documents or the like has also been proposed, in which natural language processing technology is used to learn from good examples and bad examples.

However, in development tasks of a complicated system, hierarchical dependencies exist, and in a case where deliverables of each stage have a defect, rework occurs. Therefore, efficient information management is required in each stage of a development process.

### SUMMARY

It is a main object of the present disclosure to provide an information processing apparatus, an information processing method, and a non-transitory computer-readable storage medium that contribute to realizing efficient information management in each stage of a development process.

According to a first aspect of the present disclosure, there is provided an information processing apparatus including: an acquisition means that acquires at least information related to requirements for a system or restrictions on the system from a database that stores information related to the system; and a satisfaction determination means that determines, based on the acquired information related to requirements for the system or restrictions on the system, whether or not information necessary for execution of one design task among a plurality of design tasks in a phased design flow of the system is included in design information of the one design task.

According to a second aspect of the present disclosure, there is provided an information processing method of an information processing apparatus, the information processing method including: acquiring at least information related to requirements for a system or restrictions on the system from a database that stores information related to the system; and determining, based on the acquired information related to requirements for the system or restrictions on the system, whether or not information necessary for execution of one design task among a plurality of design tasks in a phased design flow of the system is included in design information of the one design task.

According to a third aspect of the present disclosure, there is provided a non-transitory computer-readable storage medium storing a program causing a computer mounted on an information processing apparatus to perform processing for: acquiring at least information related to requirements for a system or restrictions on the system from a database that stores information related to the system; and determining, based on the acquired information related to requirements for the system or restrictions on the system, whether or not information necessary for execution of one design task among a plurality of design tasks in a phased design flow of the system is included in design information of the one design task.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment disclosed in the present application;

FIG. 4 is a diagram illustrating a system provided by the information processing apparatus according to the embodiment disclosed in the present application;

FIG. 5 is a diagram illustrating an example of a processing configuration of the information processing apparatus according to the embodiment disclosed in the present application;

FIG. 6 is a diagram illustrating an example of a requirement information table according to the embodiment disclosed in the present application;

FIG. 7 is a diagram illustrating an example of a constraint information table according to the embodiment disclosed in the present application;

FIG. 8 is a diagram illustrating an example of a design result table of a preceding design task according to the embodiment disclosed in the present application;

FIG. 9 is a diagram illustrating an example of a constraint condition table of a current design task according to the embodiment disclosed in the present application;

FIG. 10 is a flowchart illustrating an example of an operation of a satisfaction determination unit according to the embodiment disclosed in the present application;

FIG. 11 is a flowchart illustrating an example of an operation of the information processing apparatus according to the embodiment disclosed in the present application;

FIG. 12 is a diagram illustrating an example of a processing configuration of the information processing apparatus according to the embodiment disclosed in the present application;

FIG. 13 is a flowchart illustrating an example of an operation of a retroactive determination unit according to the embodiment disclosed in the present application;

FIG. 14 is a diagram illustrating an example of a processing configuration of the information processing apparatus according to the embodiment disclosed in the present application;

FIG. 15 is a diagram illustrating an overall structure of the information processing apparatus including an inquiry unit and a flow of information according to the embodiment disclosed in the present application;

FIG. 16 is a flowchart illustrating an example of an operation of the information processing apparatus according to the embodiment disclosed in the present application;

FIG. 17 is a diagram illustrating an example of an expert database according to the embodiment disclosed in the present application; and

FIG. 18 is a diagram illustrating an example of a hardware configuration of the information processing apparatus according to the embodiment disclosed in the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. It should be noted that, in the present description and drawings, elements that can be described in a like way will be denoted by a like reference character, and redundant description thereof will be omitted as needed.

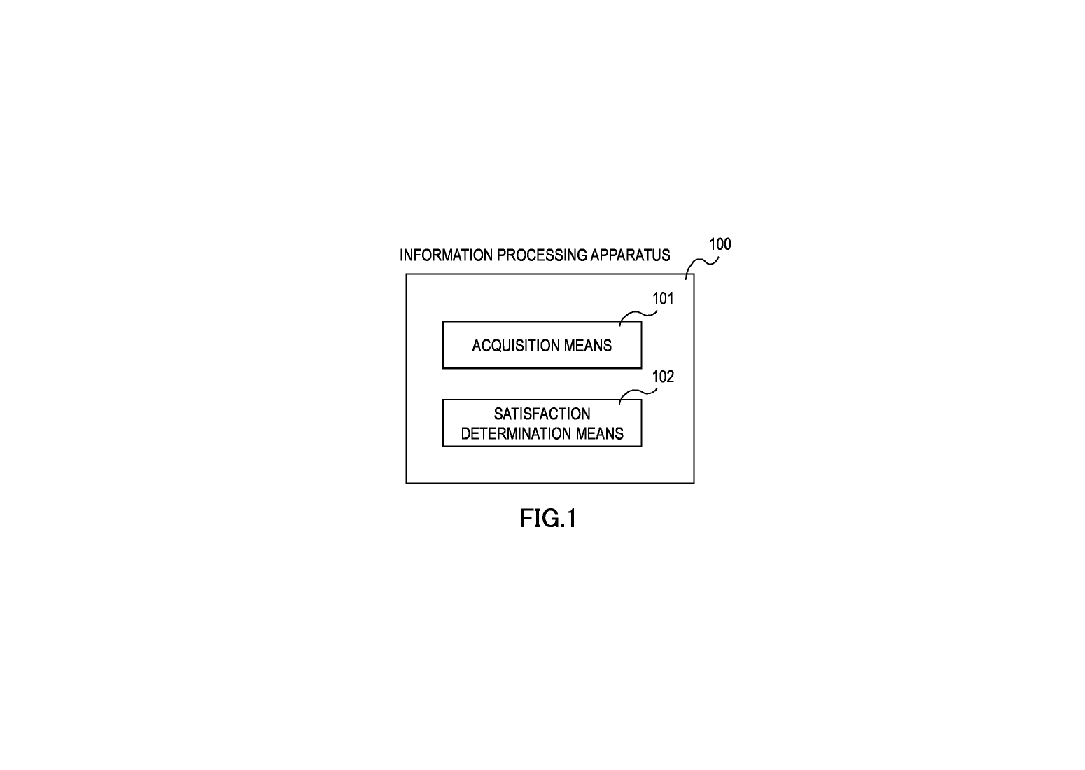

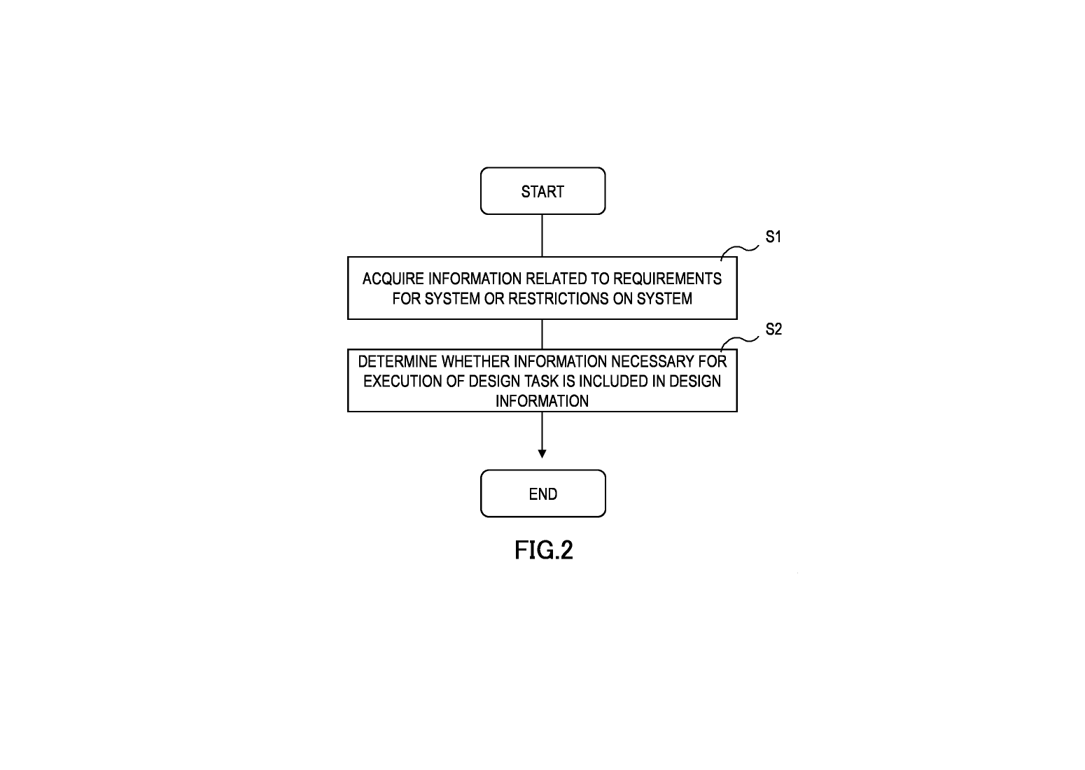

An information processing apparatus 100 according to an example embodiment includes an acquisition means 101 and a satisfaction determination means 102 (see FIG. 1). The acquisition means 101 acquires at least information related to requirements for a system or restrictions on the system from a database that stores information related to the system (step S1 in FIG. 2). The satisfaction determination means 102 determines, based on the acquired information related to requirements for the system or restrictions on the system, whether or not information necessary for execution of one design task among a plurality of design tasks in a phased design flow of the system is included in design information of the one design task (step S2).

The information processing apparatus 100 determines whether or not information necessary to satisfy requirements for the system or restrictions on the system or the like is included (exists) in design information of a design task. The information processing apparatus 100 is able to notify the user of the fact in a case where the necessary information is not included. As a result, efficient information management is realized at each stage of the development process.

Hereinafter, specific example embodiments will be described in more detail with reference to drawings.

### First Example Embodiment

A first example embodiment will be described in more detail with reference to drawings.

### Configuration of System and Schematic Operation

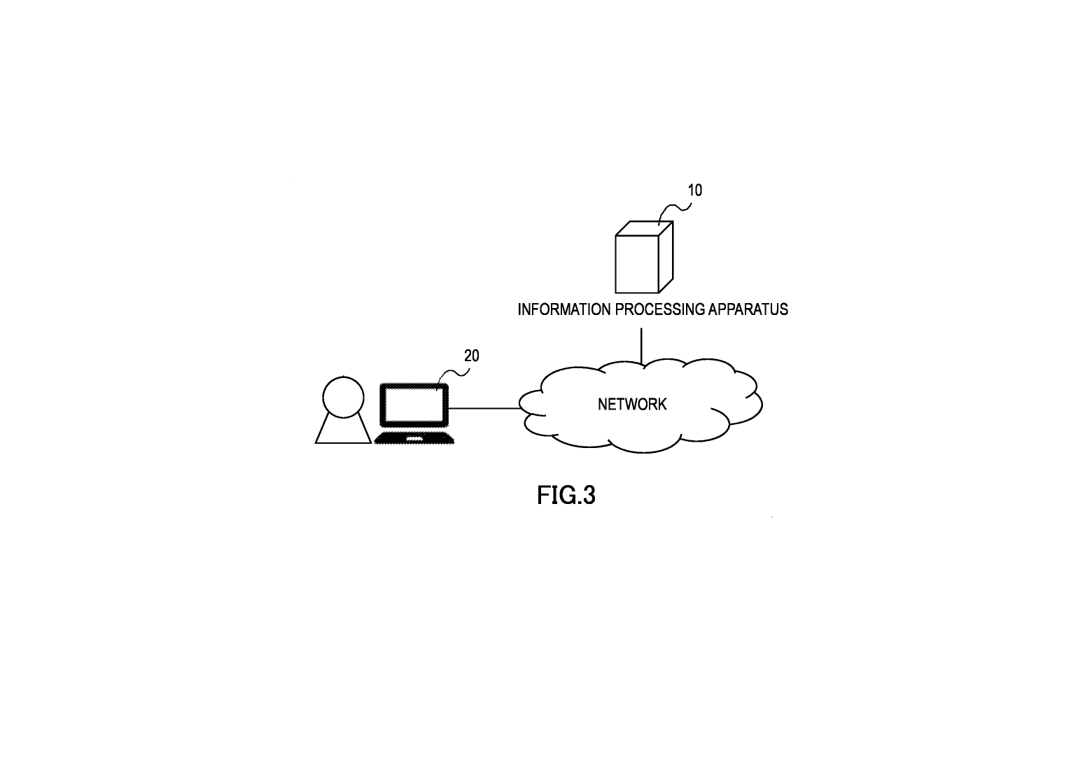

As shown in FIG. 3, an information processing system according to the first example embodiment includes an information processing apparatus 10 and a terminal 20.

The information processing apparatus 10 is the information processing apparatus that supports system design and deliverable management by a user. For example, the information processing apparatus 10 is a server installed on a network (on a cloud).

A user operates the terminal 20 to access the information processing apparatus 10. The user inputs various information into the information processing apparatus 10 and acquires various information from the information processing apparatus 10.

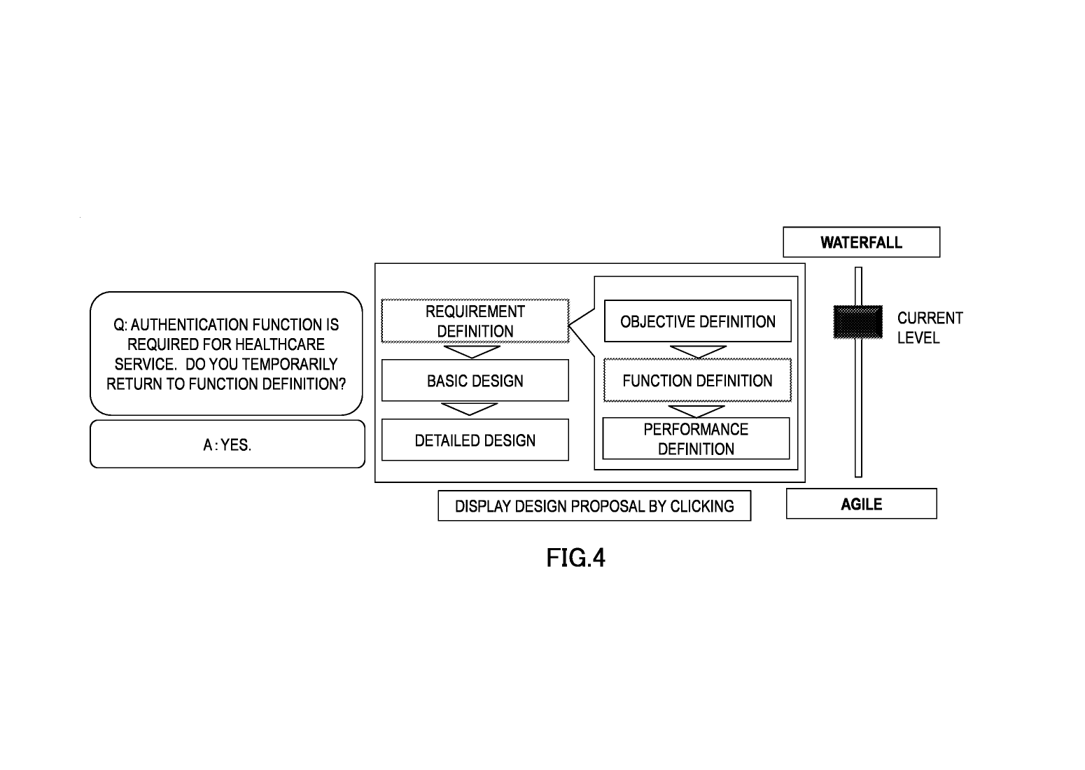

Referring to FIG. 4, an outline of the information processing apparatus 10 according to an embodiment disclosed in the present application will be described. FIG. 4 visualizes a system provided by the information processing apparatus 10 according to the embodiment disclosed in the present application.

FIG. 4 is configured of three parts. Specifically, FIG. 4 is configured of three parts including a question-and-answer section on the left, a waterfall-type development process in the center, and elements of agile development on the right.

The waterfall model indicates a development method of proceeding step by step with development steps. The waterfall model is named because each phase proceeds sequentially from top to bottom like a waterfall.

On the other hand, agile development means a flexible and iterative development approach and has a feature of being able to quickly respond to changes in requirements.

In a question-and-answer section on the left, there are shown a question of "Authentication function is required for healthcare service. Do you temporarily return to function definition?" and an answer of "Yes." to the question. In the question-and-answer section, a question presented by the information processing apparatus 10 and an answer thereto are shown in a case where a new requirement or change occurs during a development process.

A central portion represents respective stages of the waterfall model and continues from the top as "requirement definition", "basic design", and "detailed design".

Requirement definition is a stage of clarifying functions and performance required of a system. Basic design is a stage of determining an overall structure of a system. Detailed design is a stage of deciding a more concrete implementation method.

On the right, "objective definition", "function definition", and "performance definition" are arranged from top to bottom. These items indicate iterative elements in agile development.

Objective definition is a process of clarifying an objective of a system and a goal to be achieved. Function definition is a process of identifying specific functions that a system should have. Performance definition is a process of defining performance requirements of a system.

At the right end of FIG. 4, there is a description "waterfall", and under it, a block ("arrow") indicating "current hierarchy" is arranged. The block functions as an indicator indicating a current position of a development process.

At the bottom of FIG. 4, there is a button of "display design proposal by clicking", and the button indicates a function of displaying detailed information of each development stage. A user is able to proceed with development interactively, taking into consideration the entire process, in accordance with a desired development style. In other words, the user is able to flexibly proceed with development while making decisions and corrections at each development stage through interaction with the system.

Further, the information processing apparatus 10 proposes rework modification to a process as necessary while confirming deliverables of each process. By means of this function, even in a case where problems or points of improvement are found during an intermediate stage of development, the user is able to return to a preceding stage at an appropriate timing and perform corrections. As a result, creation of deliverables of higher quality can be expected.

Subsequently, details of the information processing apparatus 10 according to the first example embodiment will be described.

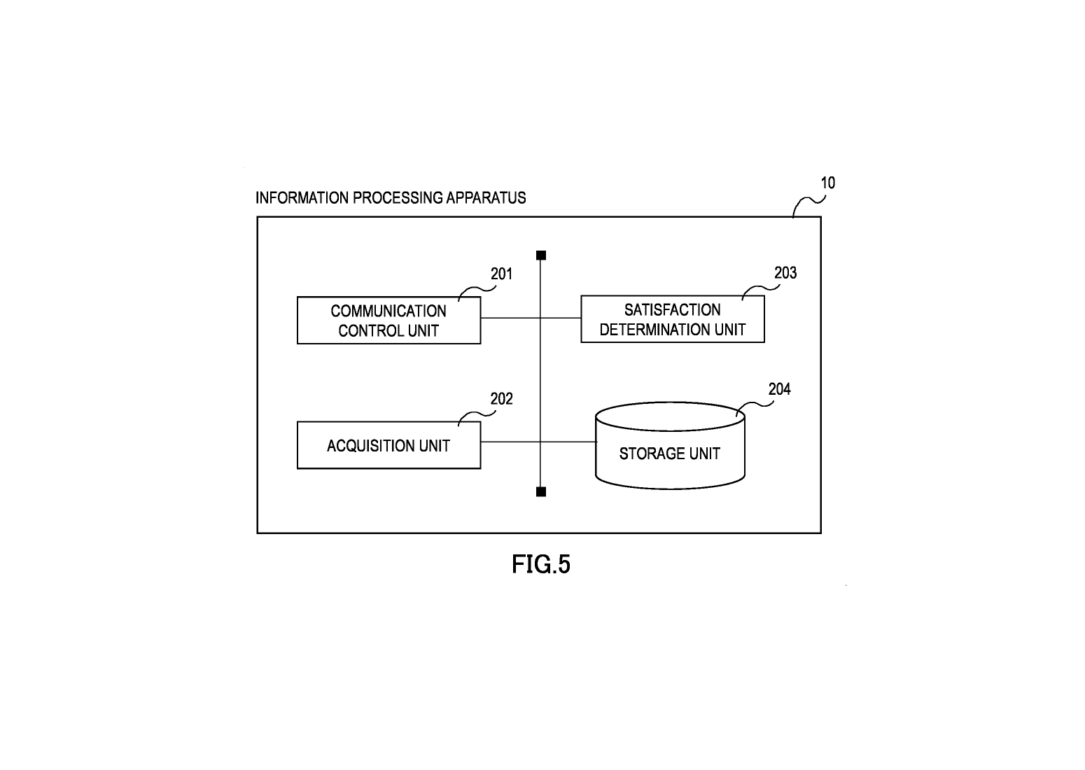

FIG. 5 is a diagram illustrating an example of a processing configuration (processing modules) of the information processing apparatus 10 according to the embodiment disclosed in the present application. Referring to FIG. 5, the information processing apparatus 10 includes a communication control unit 201, an acquisition unit 202, a satisfaction determination unit 203, and a storage unit 204.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The acquisition unit 202 is means for acquiring information from a database, the terminal 20 used by a user, or the like. For example, the acquisition unit 202 receives, as input data, design information, requirement information, constraint information, and design results of design tasks related to a system, which are stored in a database. More specifically, the acquisition unit 202 acquires at least information related to requirements for the system or restrictions on the system from a database that stores information related to the system.

The acquisition unit 202 plays a role of transmitting the information to the satisfaction determination unit 203.

It should be noted that design information is concrete design information of each stage (design process). For example, information described in a requirement definition document, a basic design document, and a detailed design document or the like corresponds to the design information.

The satisfaction determination unit 203 is means for receiving the information transmitted from the acquisition unit 202 and determining whether or not information necessary for execution of a design task is sufficiently included in the design information.

The satisfaction determination unit 203 determines, based on the information related to requirements for the system or restrictions on the system acquired by the acquisition unit 202, whether or not information necessary for execution of one design task among a plurality of design tasks in a phased design flow of the system is included in design information of the one design task.

For example, the satisfaction determination unit 203 evaluates, based on predetermined criteria, a degree of satisfaction with respect to acquired information (for example, requirement information and constraint information) related to each element (each design element) of design information. The satisfaction determination unit 203, in a case where information is insufficient (in a case where each design element does not satisfy requirements for the system or restrictions on the system or the like), requests the acquisition unit 202 to acquire additional information. Alternatively, in a case where the information is not included, the satisfaction determination unit 203 may notify a user to that effect.

The satisfaction determination unit 203, in a case where the information acquired from the acquisition unit 202 is sufficiently included in the design information (in a case where each design element satisfies requirement information or the like), issues an instruction to a user to proceed to a next processing stage.

With this configuration, the information processing apparatus 10 efficiently collects information necessary in a design process and appropriately determines a degree of satisfaction of the collected information (design elements) (degree of satisfaction with respect to requirements for the system, constraints on the system, or the like). As a result, decision-making and processing based on necessary and sufficient information are performed at each stage of a design task, and improvement in quality and efficiency of an entire design process can be expected.

### Detailed Description of Information Used by the Satisfaction Determination Unit 203

Here, information (table information) used by the satisfaction determination unit 203 will be described in more detail.

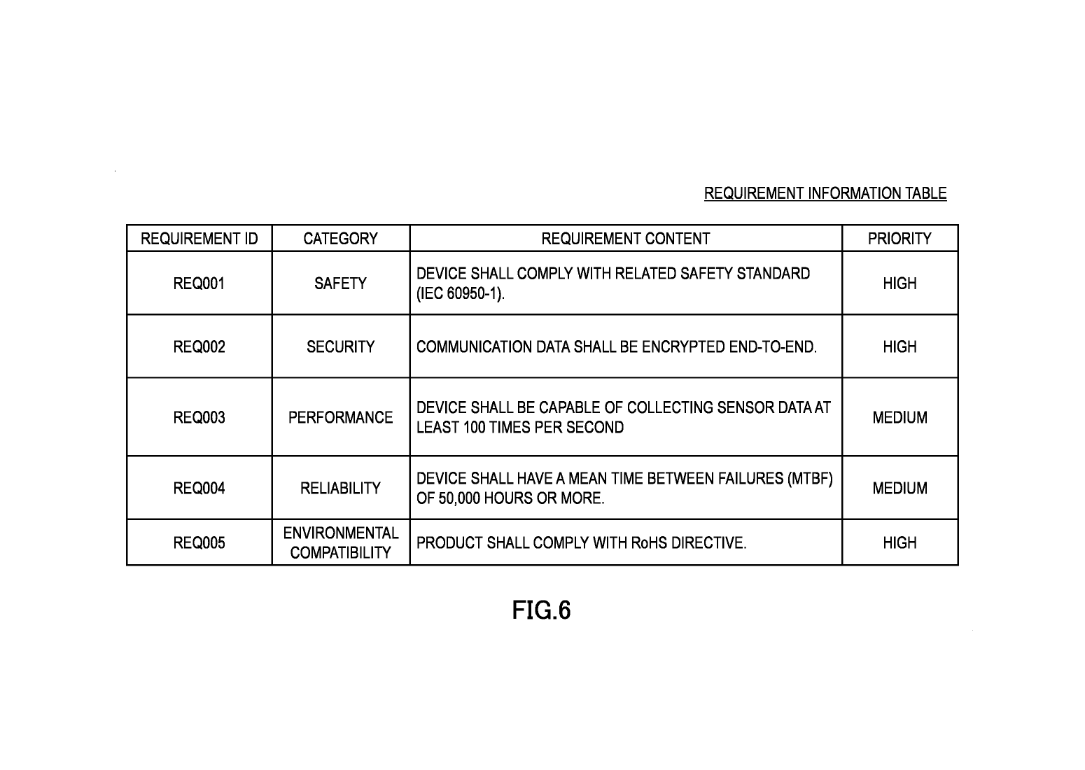

FIGS. 6 to 9 illustrate four main data tables (table information) used as input information (input data) of a design process.

A requirement information table shown in FIG. 6 defines basic requirements that a product (final system) should satisfy. As shown in FIG. 6, the requirement information table is configured of columns of a requirement ID, a category, a requirement content, and a priority.

For example, requirement information of requirement ID "REQ001" indicates a high-priority safety requirement and is handled as particularly important information in a design process. Alternatively, requirement ID "REQ003" defines specific performance targets of a device with a medium priority.

The satisfaction determination unit 203 evaluates whether or not information corresponding to the requirements has been sufficiently collected (has been reflected in design), and in a case where the information is insufficient, instructs the acquisition unit 202 to acquire additional information.

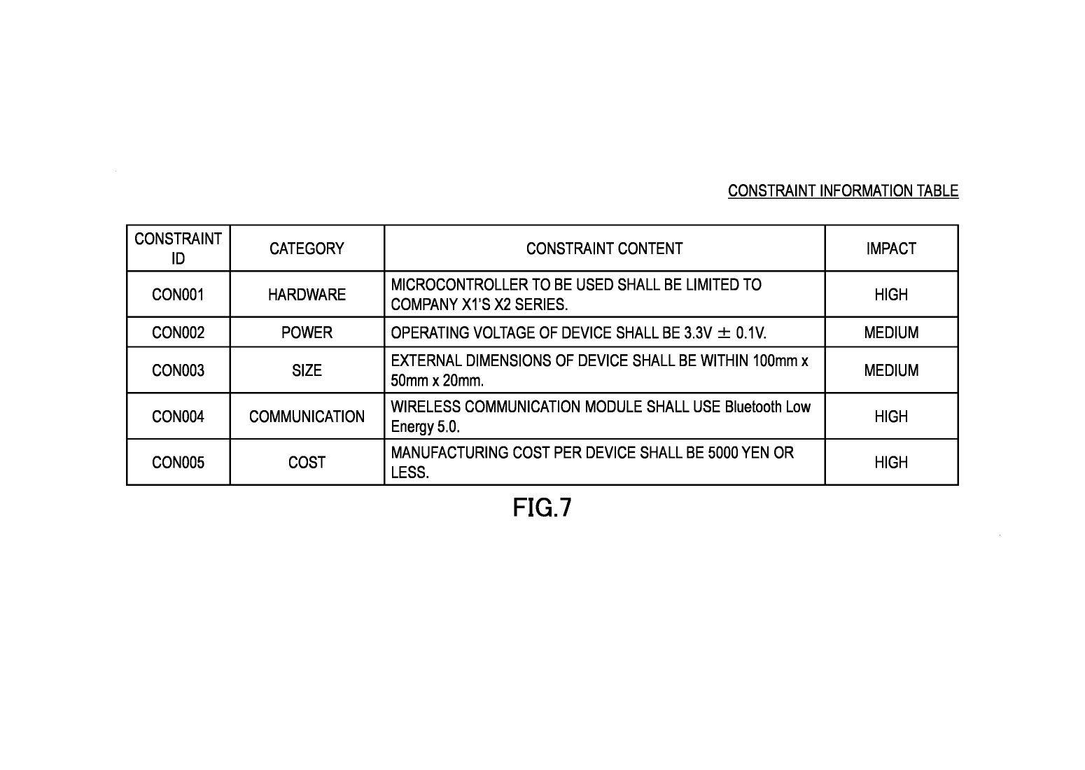

A constraint information table shown in FIG. 7 defines specific restrictions related to design or manufacture. As shown in FIG. 7, the constraint information table includes columns of a constraint ID, a category, a constraint content, and an impact degree.

A high-impact constraint such as constraint ID "CON001" is important information that affects many aspects of design.

The satisfaction determination unit 203 evaluates whether or not detailed information related to the constraints is sufficiently included (is reflected in design), and in a case where the information is insufficient, requests the acquisition unit 202 to acquire additional information with high priority.

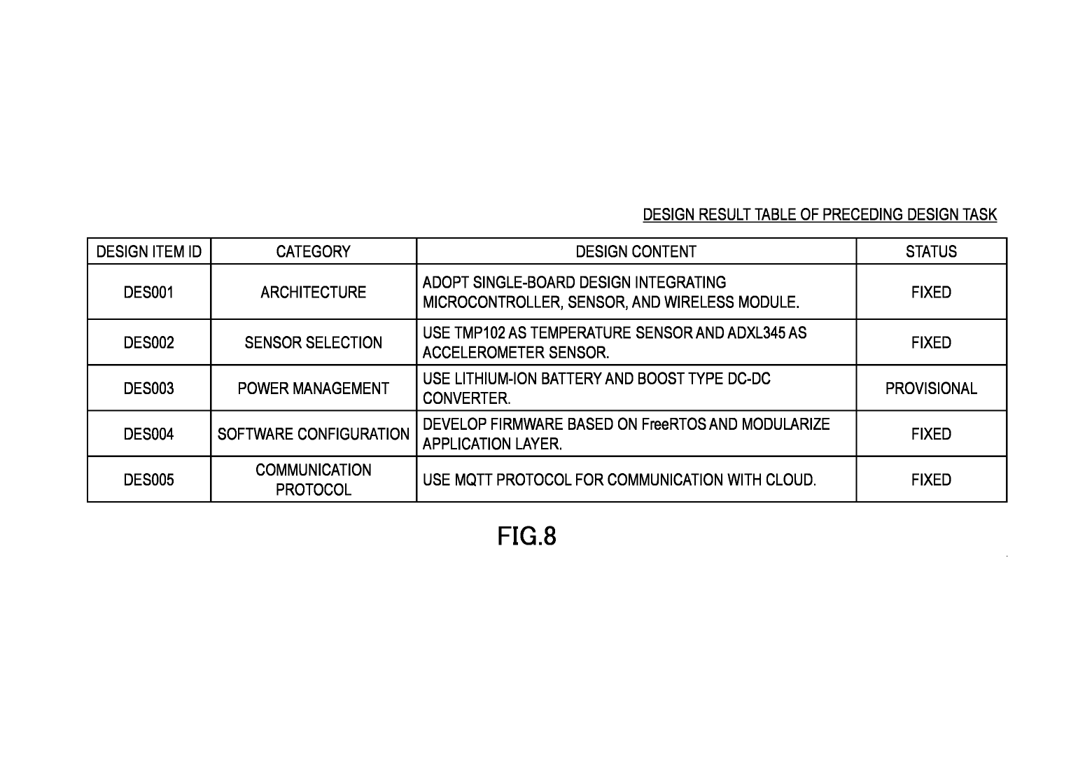

A design result table of a preceding design task shown in FIG. 8 indicates design decisions that have already been made. As shown in FIG. 8, the design result table of the preceding design task is configured of columns of a design item ID, a category, a design content, and a status.

Design item ID "DES001" is a design item in a fixed status. Such design items in the fixed status are important information that greatly affects subsequent design.

The satisfaction determination unit 203 evaluates whether or not detailed information regarding the design decisions (design results) is sufficiently recorded in the design information. For a provisional status item such as design item ID "DES003", the satisfaction determination unit 203 identifies additional information necessary for final decision and may prompt a user or the like to acquire it.

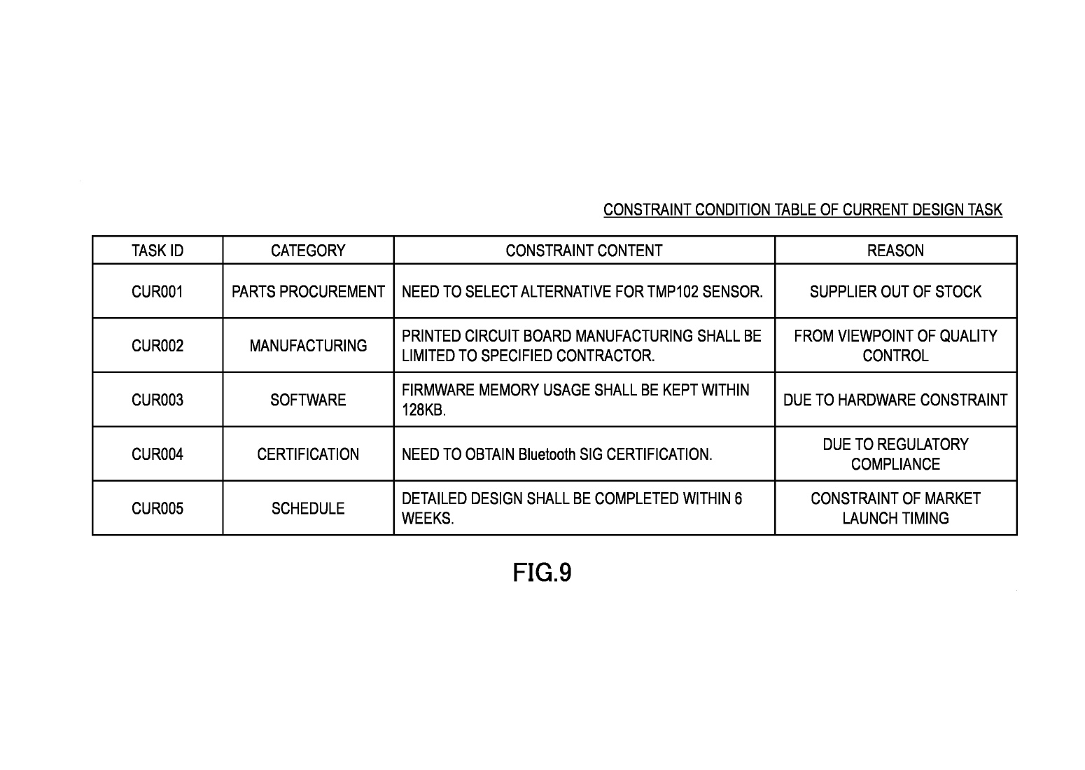

An information table of a current design task shown in FIG. 9 indicates a status of ongoing design work. As shown in FIG. 9, the information table of the current design task is configured of columns of a task ID, a category, a task content, and a progress status.

A task such as task ID "CUR001" has important consistency with preceding design results.

The satisfaction determination unit 203 evaluates whether or not information necessary for an ongoing design task is sufficiently included. The satisfaction determination unit 203 determines whether or not each design element of design information used in the ongoing design task satisfies constraint contents. The satisfaction determination unit 203, in a case where information necessary in the design information is insufficient, specifies concrete insufficient information (information to be additionally required) and issues an instruction (instruction of information acquisition) to the acquisition unit 202.

A designer of a system or the like generates the requirement information table or the like described above based on knowledge and experience obtained in past system development, and registers it in the information processing apparatus 10. Alternatively, the designer or the like updates the constraint condition table of the current design task described above at a timing in which a specification of the system is changed or at a timing in which information such as delivery time related to a component to be used is acquired from a component manufacturer or the like.

The satisfaction determination unit 203 comprehensively analyzes information of each data table described above and evaluates a degree of satisfaction of information regarding each design element. It should be noted that details of operation of the satisfaction determination unit 203 will be described below, and an outline of operation of the satisfaction determination unit 203 is as follows.

For example, in a case where design information corresponding to a high-priority requirement is insufficient or details related to a high-impact constraint are unclear, the satisfaction determination unit 203 determines that information (design elements) to be described in the design information (for example, a requirement definition document, a basic design document) is insufficient. In this case, the satisfaction determination unit 203 may instruct a user to acquire concrete additional information.

On the other hand, in a case where sufficient information is included regarding important requirements and constraints and there is no contradiction between the preceding design results and the information of the current design task, the satisfaction determination unit 203 determines that the information required to be described in the design information is satisfied. In this case, the satisfaction determination unit 203 permits a user or the system to proceed to a next design stage.

It should be noted that the database may store information related to the system described above using a graph structure. By using the graph structure, relationships between data are more clearly represented, and management and analysis of information having complex dependencies are facilitated.

In addition, in a software development process, tasks usually have a hierarchical structure. For example, an overall design is at a top level, and under it, function design and detailed design are hierarchized (also referred to as a task hierarchy tree).

The satisfaction determination unit 203 may evaluate a degree of satisfaction of information in consideration of the hierarchical structure. The database may manage information in correspondence at each hierarchical level.

### Detailed Description of Operation in the Satisfaction Determination Unit 203

The satisfaction determination unit 203 comprehensively analyzes information of four data tables shown in FIGS. 6 to 9 and design information.

For example, the satisfaction determination unit 203 verifies whether or not a safety requirement defined by requirement ID "REQ001" is achievable by a predetermined microcontroller specified in constraint information of constraint ID "CON001". In addition, the satisfaction determination unit 203 evaluates whether or not the preceding design result (single board design) of design item ID "DES001" sufficiently provides information necessary for the current design task (component procurement) of task ID "CUR001".

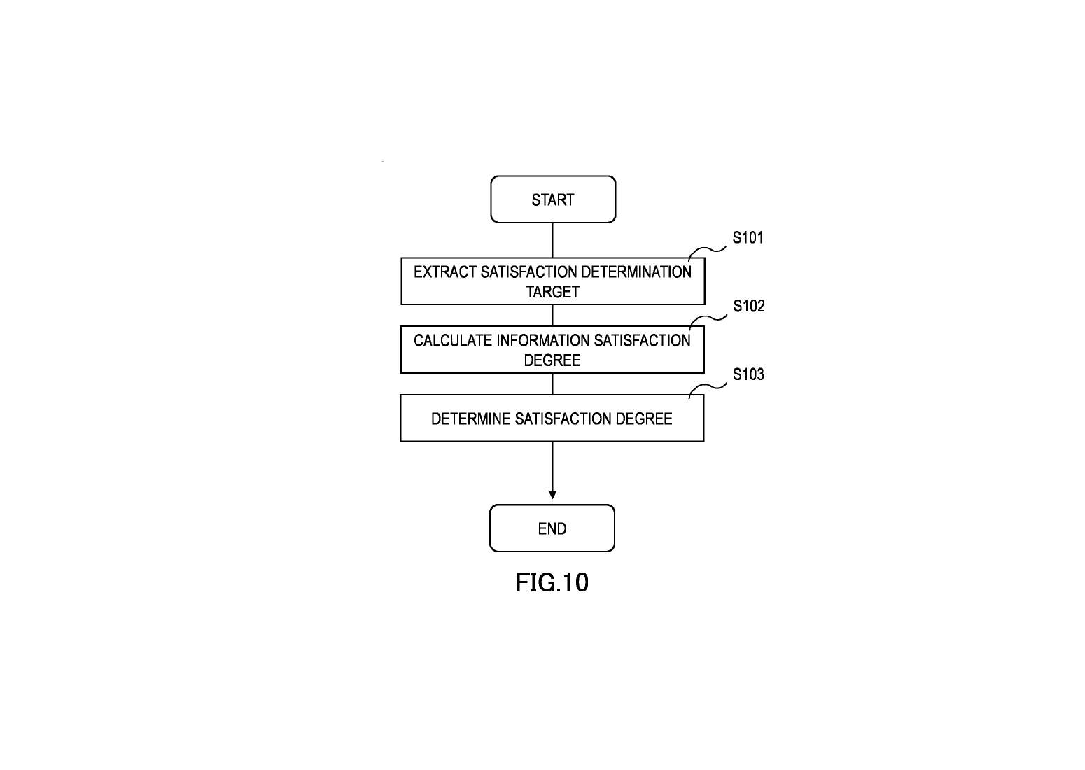

FIG. 10 is a flowchart illustrating an example of an operation of the satisfaction determination unit 203 according to the embodiment disclosed in the present application. Referring to FIG. 10, an operation of the satisfaction determination unit 203 will be described.

The satisfaction determination unit 203 extracts a satisfaction determination target in each design stage by using data described in the four pieces of table information described above. The satisfaction determination unit 203 extracts at least one or more satisfaction determination targets from the table information by using the four pieces of table information and design information (step S101).

For example, the satisfaction determination unit 203 extracts the satisfaction determination targets (items described in the database) by using a large language model (LLM; Large Language Model). For example, the satisfaction determination unit 203 extracts the satisfaction determination targets by inputting a prompt such as "Extract items related to design information from among items described in the requirement information, the constraint information, the design results of the preceding design task, and the constraint condition table of the current design task." into the LLM.

Next, the satisfaction determination unit 203 calculates an information satisfaction degree of each design element based on the extracted information (satisfaction determination targets) (step S102).

More specifically, the satisfaction determination unit 203 calculates, as an information satisfaction degree, a degree or ratio to which each design item described in design information in a design process (for example, a requirement definition document or a basic design document) satisfies the extracted information (items extracted from the four pieces of table information).

At that time, the satisfaction determination unit 203 uses a predefined evaluation function. As a method of constructing the evaluation function, for example, a design using predetermined rules may be adopted. For example, with respect to function requirements, the satisfaction determination unit 203 calculates completeness of design information (design elements) with respect to the required functions and normalizes the calculated value in a range from 0 to 1.

The satisfaction determination unit 203 determines whether or not a design element satisfies the satisfaction determination target (satisfaction determination; step S103).

Specifically, the satisfaction determination unit 203 compares the calculated information satisfaction degree of each design element with a predefined threshold. The threshold is set based on past project experience, industry standards, or the like, and serves as a criterion for determining sufficiency of the information.

In a case where the information satisfaction degree is equal to or greater than the threshold, the satisfaction determination unit 203 determines that the design element satisfies the satisfaction determination target (the information is satisfied). In a case where the information satisfaction degree is less than the threshold, the satisfaction determination unit 203 determines that the design element does not satisfy the satisfaction determination target (the information is not satisfied).

At the time of satisfaction determination, the satisfaction determination unit 203 may refer to a user specification related to a development model shown in FIG. 4.

For example, in a case where waterfall development is specified, the satisfaction determination unit 203 applies stricter criteria (a higher threshold). Since in waterfall development it is important to complete each phase before proceeding to the next phase, the satisfaction determination unit 203 requires much detailed information to narrow down design results.

For example, the satisfaction determination unit 203 confirms in a requirement definition phase that all function requirements and non-function requirements are clearly defined and documented.

Alternatively, in a design phase, the satisfaction determination unit 203 requires that detailed information such as architecture, a data model, and interface specifications be included. Until the satisfaction determination unit 203 determines that the information as described above is sufficiently detailed and complete, transition to a next phase is not permitted.

On the other hand, in a case where agile development is specified, the satisfaction determination unit 203 may adopt more flexible criteria (a lower threshold).

Since in agile development rapid iteration and continuous improvement are emphasized, the satisfaction determination unit 203 may judge that even relatively small amounts of information are "sufficient" and permit early output of design results.

In this case, the satisfaction determination unit 203 may, for example, utilize a language model to complement or presume missing information.

For example, even in a case where part of details of a user story is missing, the language model may perform reasoning based on knowledge of past similar projects and provide tentative details. As a result, a development team is able to rapidly create a prototype and is able to obtain feedback from the prototype.

As a specific implementation example, the satisfaction determination unit 203 performs operations such as identification of a development style, adjustment of determination criteria, utilization of a language model, construction of a feedback loop, and adaptive determination. With this development style adjustment function, the satisfaction determination unit 203 flexibly adapts to various project methodologies and supports realization of an efficient design process while maximizing advantages of each approach.

For example, the satisfaction determination unit 203 emphasizes completeness and accuracy in waterfall development and prioritizes rapidity and adaptability in agile development. As a result, an optimal judgment suited to characteristics of a project is provided.

In addition, the satisfaction determination unit 203 may execute additional analysis using external tools. The additional analysis includes requirement traceability analysis, design consistency check, completeness evaluation of documents, and the like. Output results of these external tools may also be incorporated into calculation of the information satisfaction degree.

In a case where the satisfaction determination unit 203 utilizes external tools, it integrates evaluation results (information satisfaction degrees) of respective design elements and analysis results of the external tools. The satisfaction determination unit 203 applies weighting to each element (information satisfaction degrees, analysis results of the external tools) and calculates a weighted average. The weighting coefficients may be adjusted in accordance with the nature and priority of a project.

The satisfaction determination unit 203 finally normalizes the calculated weighted average value into a range from 0 to 1. The satisfaction determination unit 203 outputs the normalized weighted average value as an information satisfaction degree index value (a new information satisfaction degree). The lower the information satisfaction degree index value is, the more it indicates that additional information needs to be acquired.

It should be noted that the above example describes a case where the satisfaction determination unit 203 calculates an information satisfaction degree using an evaluation function constructed based on predetermined rules. A machine learning model may be used in the evaluation function.

For example, the satisfaction determination unit 203 is able to use a machine learning model, particularly a supervised learning model, in order to calculate an information satisfaction degree. In this case, past project data is used as training data, and the relationship between input features (presence or absence and level of detail of various design information) and target variables (degree of actual project success or presence or absence of problems caused by lack of information) is learned.

An advantage of the satisfaction determination unit 203 using a machine learning model is that it is able to capture complex interactions among a large number of variables. In addition, another advantage of the satisfaction determination unit 203 using a machine learning model is that the model is able to be updated every time new data is obtained, thereby realizing improvement of prediction accuracy.

In this way, by utilizing machine learning, the satisfaction determination unit 203 is able to evaluate the satisfaction degree of information more precisely and flexibly, and is able to realize efficient information collection and optimization of the design process.

As described above, the satisfaction determination unit 203 may calculate a degree of satisfaction indicating a degree to which a design element described in the design information of the one design task satisfies the requirements for the system or the restrictions on the system, using a predetermined rule or a machine learning model. In such a case, the satisfaction determination unit 203 may adjust a criterion (a threshold) used for determining whether or not the information necessary for execution of the one design task is included in the design information of the one design task in accordance with whether waterfall development or agile development is adopted.

The storage unit 204 is means for storing information necessary for operation of the information processing apparatus 10. For example, the database described above is constructed in the storage unit 204.

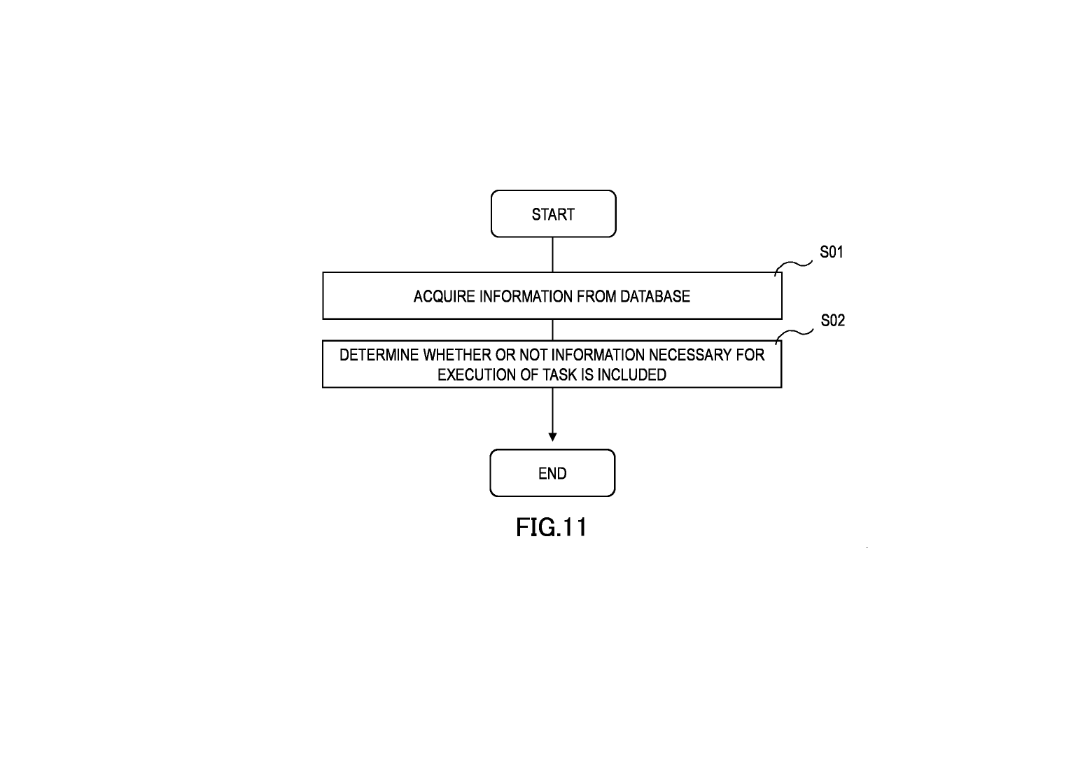

Summarizing the operation of the information processing apparatus 10, it is as shown in a flowchart of FIG. 11.

First, the acquisition unit 202 of the information processing apparatus 10 acquires information from a database (step S01). At the time of acquiring the information, various data related to a design task (requirement information, restriction information, design results of a preceding design task, information of a current design task, and so on) is extracted from the database.

Next, the satisfaction determination unit 203 of the information processing apparatus 10 determines whether or not information necessary for execution of the task is included (step S02). The satisfaction determination unit 203 analyzes information received from the acquisition unit 202, and evaluates whether or not information necessary to properly execute the current design task is sufficiently included. In the determination process, completeness, accuracy, and relevance of the information are verified by using predefined criteria or a machine learning model.

### Terminal

A detailed description of the terminal 20 will be omitted. Examples of the terminal 20 include a portable terminal device such as a smartphone, a portable phone, a game console, or a tablet and a computer (a personal computer or a laptop computer). The terminal 20 is able to be any equipment or device as long as the terminal 20 can accept an operation by a user and is able to communicate with the information processing apparatus 10.

As described above, the information processing apparatus 10 according to the first example embodiment determines whether or not information necessary to satisfy requirements for the system or restrictions on the system or the like is included (exists) in design information of a design task. The information processing apparatus 10 is able to notify the user to that effect in a case where the required information is not sufficiently included. As a result, efficient information management is realized at each stage of the development process.

### Second Example Embodiment

Next, a second example embodiment will be described in detail with reference to drawings.

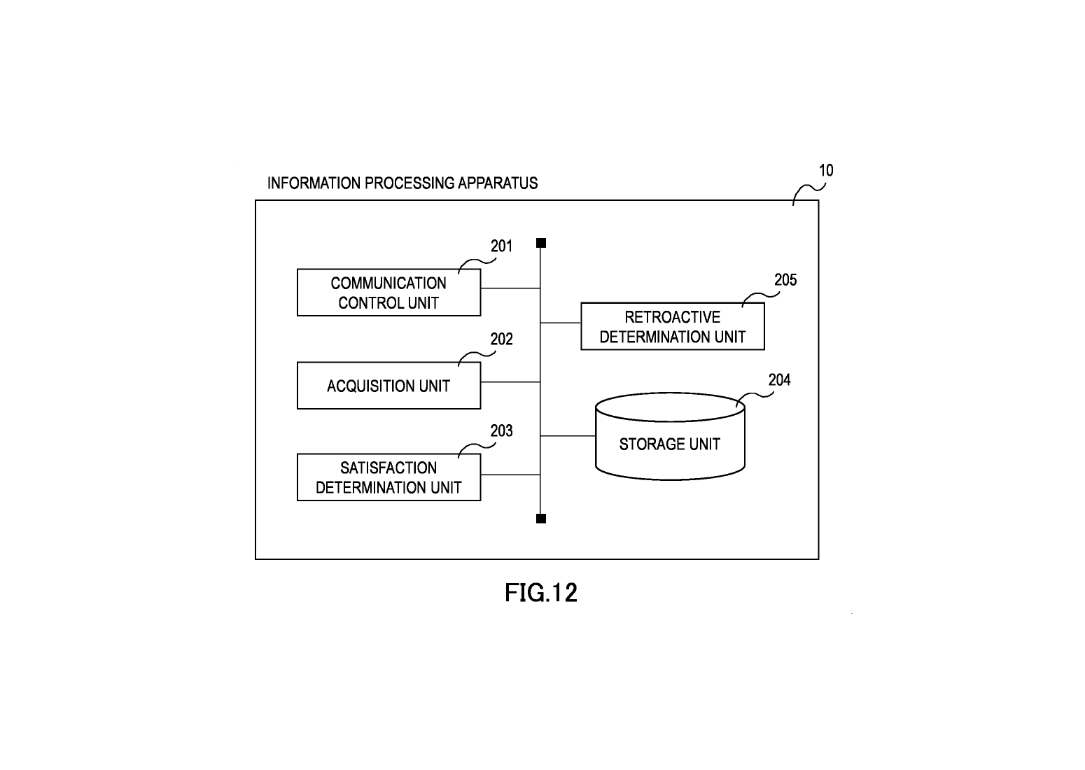

The information processing apparatus 10 according to the second embodiment differs from the information processing apparatus 10 according to the first embodiment in that it includes a retroactive determination unit 205 (see FIG. 12).

The following description will be made with a focus on the difference between the first example embodiment and the second example embodiment.

The retroactive determination unit 205 acquires information from the acquisition unit 202. The retroactive determination unit 205 acquires newly input information and modification contents of existing information from the acquisition unit 202. The retroactive determination unit 205 determines whether or not the acquired information affects design results of an upper task. The retroactive determination unit 205 proposes a retroactive modification (a modification of design information of the upper task, a change of design information of the upper task) to the user based on the determination result.

In a case where the satisfaction determination unit 203 determines "not satisfied," the retroactive determination unit 205 analyzes newly input information or modification contents of existing information, and determines whether or not the existing modifications or the like are consistent with requirements and restrictions defined in an upper task.

In a case where consistency is not present or re-examination of an upper task is determined to be necessary, the retroactive determination unit 205 identifies the relevant upper task and proposes the necessity of a retroactive modification to the user.

### Detailed Operation Description of the Retroactive Determination Unit 205

The specific operation of the retroactive determination unit 205 will be described in detail.

The retroactive determination unit 205 determines whether or not newly input information or modification contents of existing information affect design results of an upper task, and proposes a retroactive modification (a modification of design information in the upper task, change of design information in the upper task) to the upper task as necessary.

Here, the "upper task" refers to a task executed at an earlier stage of the design process than a current task. For example, a basic design for a detailed design or a requirement definition for a basic design corresponds to an upper task.

The retroactive determination unit 205 first acquires information related to an upper task from a database. In particular, the retroactive determination unit 205 acquires information related to the upper task associated with modification contents of existing information or the like.

For example, the retroactive determination unit 205 acquires performance requirements (for example, a communication rate of 1 Gbps) and budget information set as design results of the upper task.

The retroactive determination unit 205 simultaneously acquires a price list of communication devices as restriction information. Next, as a consistency check, the retroactive determination unit 205 determines consistency among the acquired pieces of information.

For example, the retroactive determination unit 205 determines (analyzes) whether or not a price of communication devices necessary to realize a communication rate of 1 Gbps exceeds the set budget. It should be noted that a large language model is able to be used for the analysis.

Here, in a mismatch detection stage (determination processing), it is assumed that, as a result of the analysis, it has been found that a price of communication devices satisfying requirements (that is, realizing a communication rate of 1 Gbps) exceeds the set budget. This state indicates that there is an inconsistency between requirements (performance requirements and budget) set in the upper task and restrictions (a price of communication devices).

In a determination stage of necessity of retroactive modification, it is determined that the detected inconsistency suggests a possibility that modification of design results (performance requirements or budget) of the upper task is necessary.

Therefore, the retroactive determination unit 205 determines that it is necessary to reconsider the situation retroactively to the upper task.

In a proposal stage of retroactive modification, the retroactive determination unit 205 proposes retroactive modification to an upper task to a user. For example, the retroactive determination unit 205 generates a message including contents such as "A mismatch has been detected between a performance requirement (a communication rate of 1 Gbps) and a set budget. It is necessary to return to an upper task and perform review of the performance requirement or the budget," and presents the message to the user.

In an execution stage of retroactive processing, in a case where the user agrees to retroactive modification, the retroactive determination unit 205 instructs the user to return to the corresponding upper task (in the above example, the task in which the performance requirement and the budget are set).

At that time, the retroactive determination unit 205 adds information related to the detected inconsistency (in the above example, that the price of communication devices necessary exceeds the budget) as input information of the upper task.

In a management stage of design modification, in a case where, as a result of re-examination in the upper task, modifications such as an increase of the budget or relaxation of performance requirements (for example, lowering of a communication rate) are made, the retroactive determination unit 205 records these modifications and proposes retroactive modification also with respect to other tasks that may be affected by the modifications as necessary.

In this way, the retroactive determination unit 205 continuously monitors consistency among tasks throughout the entire design process and proposes retroactive modification (design modification of an upper task or the like) to the upper task as necessary. By such an operation of the retroactive determination unit 205, consistency of design is maintained and risk of rework is minimized. That is, the information processing apparatus 10 supports realization of an efficient and high-quality design process.

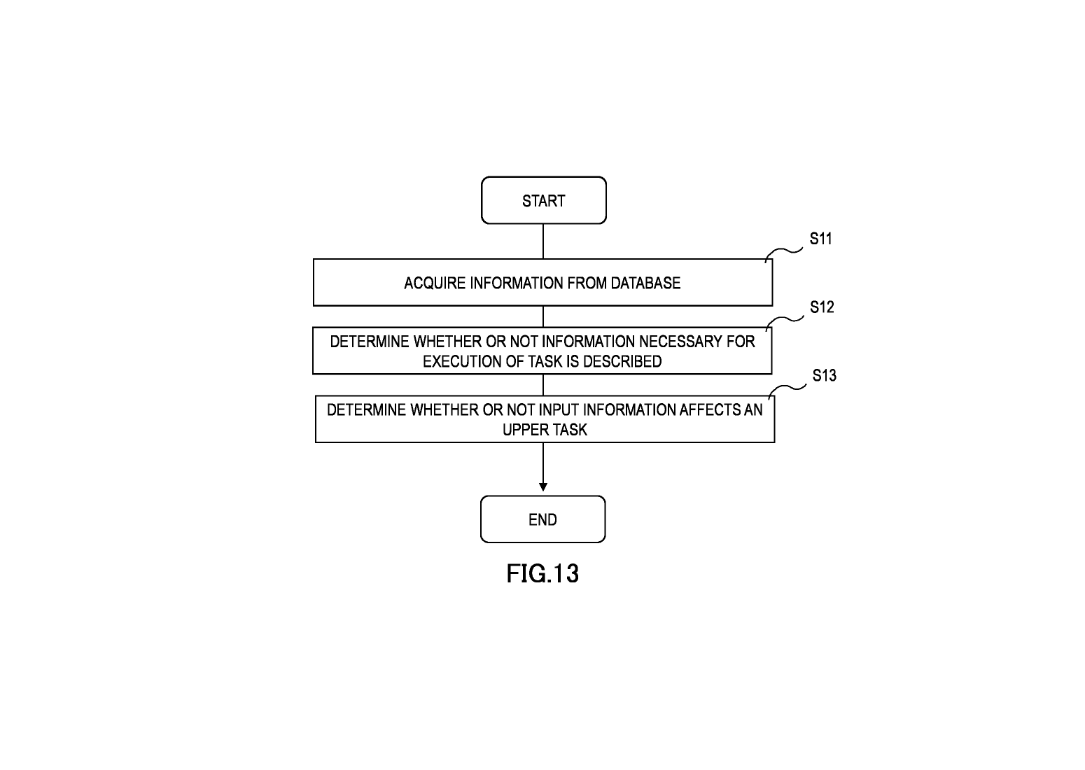

Operations of the information processing apparatus 10 will be summarized as shown in the flowchart of FIG. 13.

First, the acquisition unit 202 of the information processing apparatus 10 acquires information from a database (step S11). At the time of acquisition of the information, various data related to a design task (requirement information, constraint information, design results of a preceding design task, information of a current design task, and the like) are extracted from the database.

Next, the satisfaction determination unit 203 of the information processing apparatus 10 determines whether or not information necessary for execution of a task is included (step S12). The satisfaction determination unit 203 analyzes information received from the acquisition unit 202 and evaluates whether or not information necessary to appropriately execute a current design task is sufficiently included. In the determination process, completeness, accuracy, and relevance of the information are verified using predefined criteria or a machine learning model or the like.

The retroactive determination unit 205 of the information processing apparatus 10 determines whether or not input information affects an upper task (step S13). The retroactive determination unit 205 analyzes newly input information or modifications of existing information and determines whether or not such modifications and the like are consistent with requirements or constraints defined in the upper task. In a case where consistency is not present or re-examination of an upper task is determined to be necessary, the retroactive determination unit 205 identifies the relevant upper task and proposes necessity of retroactive modification to the user.

As described above, the information processing apparatus 10 according to the second embodiment includes the retroactive determination unit 205. The retroactive determination unit 205 determines whether or not input information, the input information being information input in accordance with a case where it is determined that the information necessary for execution of the one design task is not included in the design information of the one design task, affects a design result of an upper task of the one design task. In a case where the input information affects the design result of the upper task, the retroactive determination unit 205 proposes retroactive modification (design modification of the upper task) to the upper task. As a result, an efficient and high-quality design process is realized.

### Third Example Embodiment

Next, a third example embodiment will be described in detail with reference to drawings.

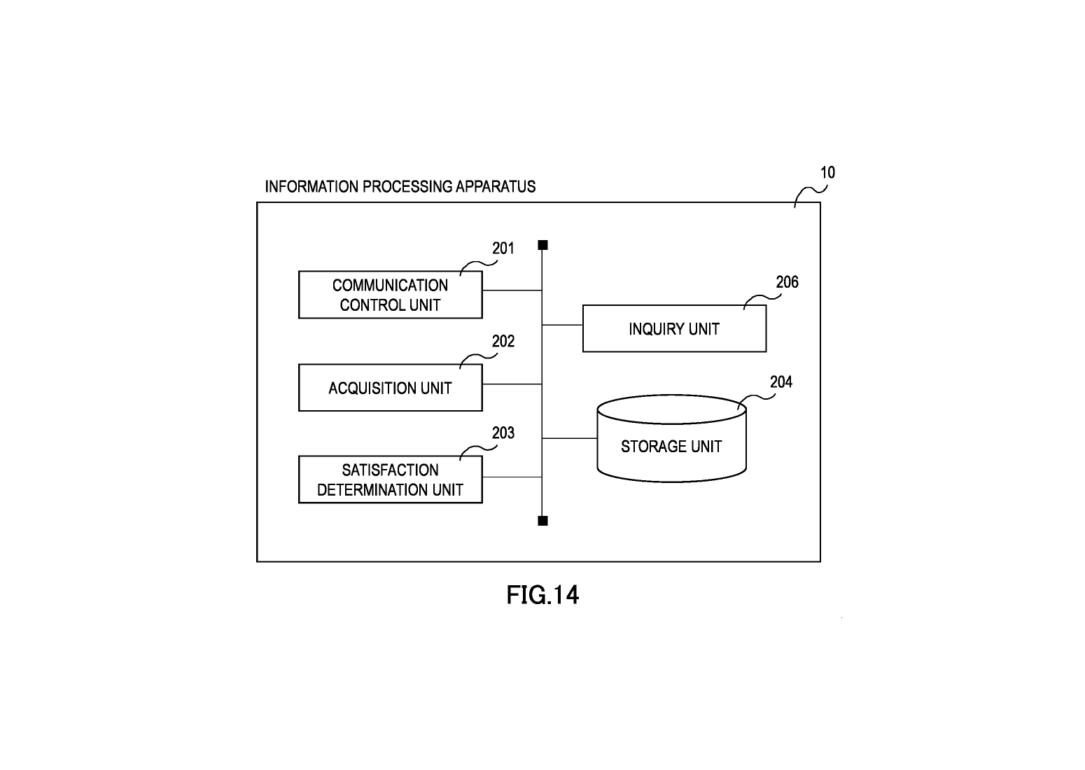

The information processing apparatus 10 according to the third embodiment differs from the information processing apparatus 10 according to the first embodiment in that it includes an inquiry unit 206 (see FIG. 14).

The following description will be made with a focus on the difference from the first example embodiment to the third example embodiment.

### Premise in which the inquiry unit 206 is required

First, a premise in which the inquiry unit 206 becomes necessary will be described.

In large-scale and complex system development projects, a large number of stakeholders are involved and a huge amount of technical information and requirements are handled. In particular, due to the spread of IoT (Internet of Things) devices and cloud services, system components have become diversified and specialized knowledge has become necessary for each. In such a situation, appropriate information management and efficient communication are indispensable.

For example, due to globalization, development is often performed by geographically distributed teams, and information exchange and decision-making on a 24-hour basis are required. In this case, it is necessary to realize accurate and prompt information sharing across time differences and language barriers.

Alternatively, by adopting agile development methods, frequent changes in requirements and rapid design reviews have come to be performed routinely. In order to support such a flexible development process, a system capable of updating information in real time and sharing the information among stakeholders is indispensable.

The inquiry unit 206 enables efficient communication among stakeholders in such a complicated system development environment.

### Outline of the Inquiry Unit 206

An outline related to the operation of the inquiry unit 206 will be described.

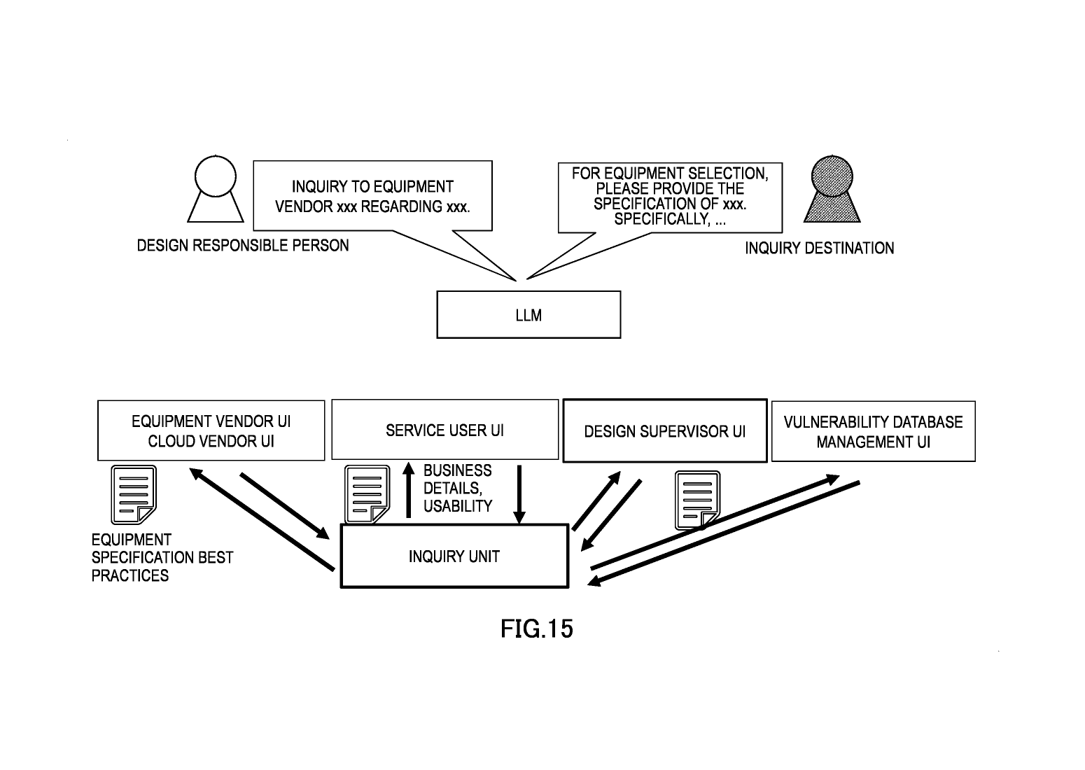

FIG. 15 is a diagram illustrating an overall structure of the information processing apparatus 10 including the inquiry unit 206 and a flow of information.

Referring to FIG. 15, the system is broadly composed of an upper user interface layer and a lower processing layer.

In the upper user interface layer, two user roles of a design responsible person and an inquiry destination are illustrated. The design responsible person makes an inquiry to an equipment vendor XXX, and the inquiry destination presents specific specifications.

In the center, the information processing apparatus 10 serving as a core of the system (a function of the inquiry unit 206 using a large language model (LLM)) is disposed. The information processing apparatus 10 processes inputs from a user and plays a role of generating appropriate responses.

In the lower portion, main components of the system are illustrated. From the left, four user interfaces, namely "equipment vendor UI/cloud vendor UI," "service user UI," "design administrator UI," and "vulnerability database management UI," are arranged.

Each UI (User Interface) described in FIG. 15 provides an interface for accessing different user layers and system functions.

The "inquiry unit" in the lower center is a central processing unit of the system, and plays a role of receiving inputs from each UI and selecting and providing an appropriate inquiry destination or information.

Further, in the lower left of FIG. 15, a document entitled "equipment specification best practices" is illustrated. The document is an information source recorded in a database and referred to in inquiry processing and response generation.

The inquiry unit 206 enables various stakeholders to access information through a plurality of user interfaces and automates communication.

The inquiry unit 206 has a function of automatically generating questions related to a design task and transmitting them to an appropriate inquiry destination.

The inquiry unit 206, in a case where a satisfaction determination target is determined as "not satisfied" by the satisfaction determination unit 203, specifies insufficient information and generates a question for acquiring the specified information.

The inquiry unit 206 automatically transmits the generated question to an appropriate inquiry destination (for example, an equipment vendor, a service user, or a design administrator).

The inquiry unit 206 receives an answer from the inquiry destination and provides the received information to the acquisition unit 202.

By such an operation of the inquiry unit 206, insufficient information is efficiently collected and the design process is smoothly advanced.

### Processing Flow

An overall processing flow of the information processing apparatus 10 according to the third embodiment including the inquiry unit 206 will be described.

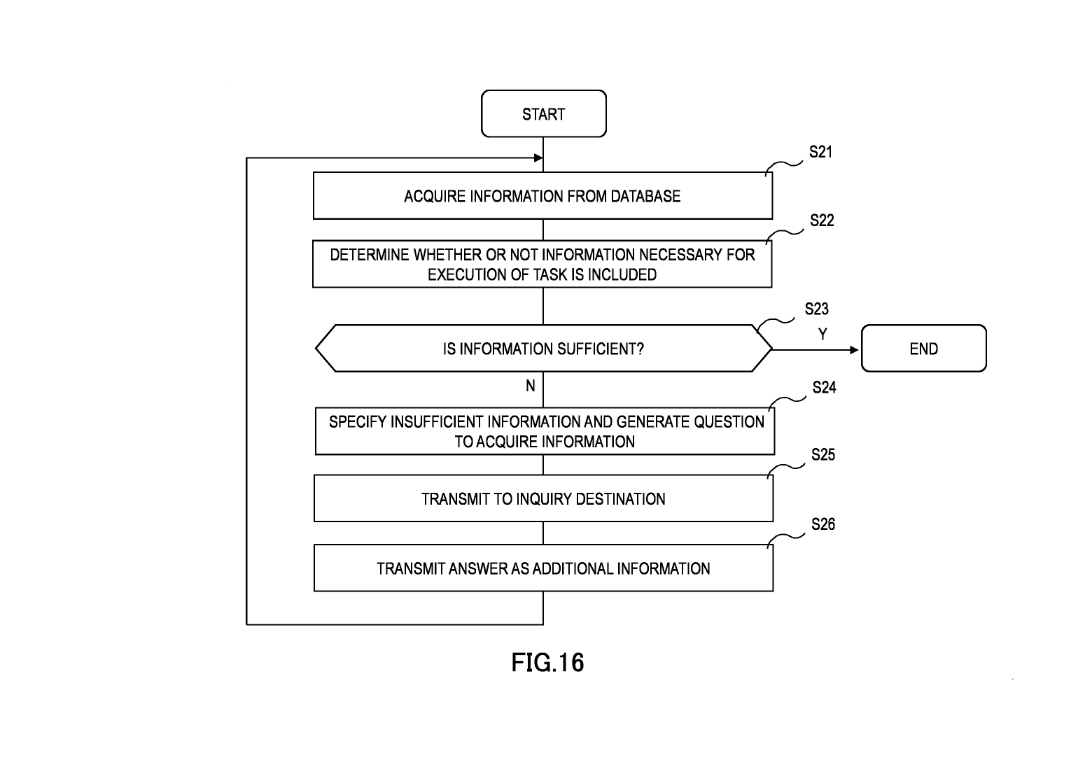

FIG. 16 is a flowchart illustrating a processing flow of the information processing apparatus 10 according to the embodiment disclosed in the present application.

First, the acquisition unit 202 acquires information from a database (step S21).

Next, the satisfaction determination unit 203 determines whether or not information necessary for execution of a task is included (step S22).

In a case where the satisfaction determination unit 203 determines that the information is "satisfied" (step S23, Yes branch), the processing is terminated.

In a case where the satisfaction determination unit 203 determines that the information is "not satisfied" (step S23, No branch), the inquiry unit 206 starts its operation.

The inquiry unit 206 specifies insufficient information and automatically generates a question for acquiring the specified insufficient information (step S24).

The inquiry unit 206 automatically transmits the generated question to an appropriate inquiry destination (for example, an equipment vendor, a service user, or a design administrator) (step S25).

Upon receiving an answer from the inquiry destination, the inquiry unit 206 transmits the received information (the answer from the inquiry destination) as additional information to the acquisition unit 202 (step S26).

The acquisition unit 202 stores the newly obtained information in the database and sends it to the satisfaction determination unit 203. The satisfaction determination unit 203 evaluates again the degree of satisfaction of the information, and the above processing is repeated until it is determined that sufficient information has been acquired.

### Operation Details of the Inquiry Unit 206

Details of the operation of the inquiry unit 206 will be described with reference to a specific example.

For example, consider a case where, in a design project of an IoT device, the satisfaction determination unit 203 determines that details of security requirements are insufficient.

In this case, the inquiry unit 206 specifies the insufficient information and automatically generates a question such as, "Regarding the security requirements of the IoT device, it is necessary to specify a concrete encryption method and an authentication protocol. Please inform us of recommended encryption algorithms and authentication methods."

One example of a method for automatic generation of questions by the inquiry unit 206 is a method of utilizing a large language model (LLM; Large Language Model).

Specifically, the inquiry unit 206 provides the LLM with prompts such as an outline of the project, the current design phase, and the type of insufficient information.

For example, a prompt such as, "In a design project of an IoT device, details of security requirements are insufficient. Specifically, specification of an encryption method and an authentication protocol is required. Generate an appropriate question for this situation." is used.

The LLM generates a question based on the given information, while considering related expertise and experiences of similar past projects.

A question generated by the LLM becomes a concrete and precise question such as, "In the security design of an IoT device, which encryption algorithm and authentication protocol are optimal, and what are the reasons for the selection?"

Furthermore, the LLM also generates additional related questions. For example, questions such as "Are there any recommendations or precautions regarding the implementation of the selected encryption method and authentication protocol?" and "How do these security functions affect the performance and power consumption of the device?" are generated (proposed).

Through this process, the inquiry unit 206 is able not only to complement insufficient information but also to automatically generate a group of questions that contribute to comprehensive understanding of the project and improvement of quality.

The inquiry unit 206 automatically transmits the generated question (the group of questions) to predetermined inquiry destinations such as security experts or related equipment vendors.

In a case where the inquiry unit 206 selects experts or equipment vendors as the transmission destinations, the inquiry unit 206 utilizes information such as internal and external expert databases, each expert’s field of expertise, years of experience, past project achievements, and evaluation scores.

The inquiry unit 206 may extract keywords by using natural language processing technology in accordance with the content of a question and match the extracted keywords with areas of expertise of experts.

For example, the inquiry unit 206 extracts experts related to keywords such as "IoT device security," "encryption," and "authentication protocol."

Next, the inquiry unit 206 sets a required experience level in accordance with the scale and importance of the project. The inquiry unit 206 filters experts who match the set importance and the like.

Furthermore, the inquiry unit 206, in consideration of achievements in past projects and evaluation scores, preferentially selects experts who have obtained high evaluations.

With respect to the selection of device vendors, the inquiry unit 206 preferentially extracts vendors related to technologies or products that are planned to be used in the project. At that time, past business records and evaluations are also taken into consideration.

In addition, the inquiry unit 206 confirms the current operating status and availability of experts or vendors, and may select candidates from which quick responses can be expected.

The inquiry unit 206 comprehensively evaluates elements such as those described above and determines an optimal expert or device vendor.

An example of an expert database will be described.

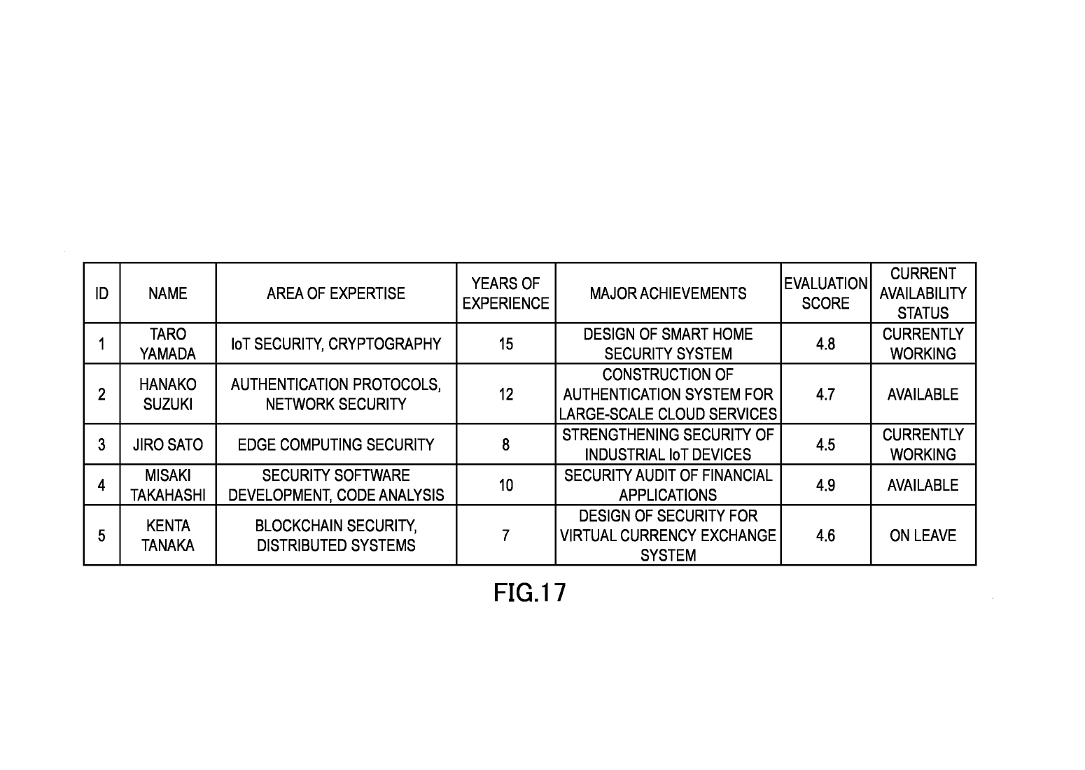

FIG. 17 is table data illustrating information related to security experts stored in an expert database.

Each row in FIG. 17 represents one expert, and different attributes are indicated in each column.

Specifically, from the left in order, an expert identification number (ID), name, specialty, years of experience, main achievements, evaluation score (out of five points), and current operating status are described.

For example, Mr. Taro Yamada with ID "1" specializes in IoT security and encryption, has 15 years of experience, has design achievements in smart home security systems, has obtained a high evaluation score of 4.8 points, and is indicated as currently in operation.

The inquiry unit 206 is able to rapidly select an optimal expert for a specific security issue or easily identify an expert having a skill set required for a project by using the data shown in FIG. 17.

In addition, by taking into consideration evaluation scores and operating statuses, the inquiry unit 206 is able to select an expert who is highly likely to provide high-quality advice and who is also able to respond immediately. The operation of the inquiry unit 206 contributes to efficient project management.

Here, it is assumed that the inquiry unit 206 acquires information as an answer from an expert stating "The use of AES-256 encryption and Auth2.0 authentication protocol is recommended."

The inquiry unit 206 provides the answer to the acquisition unit 202. The acquisition unit 202 stores the new information in a database. The satisfaction determination unit 203 evaluates the information again and determines that the security requirements are sufficiently detailed.

As described above, the inquiry unit 206 efficiently collects necessary information and supports smooth progress of the design process.

As described above, the information processing apparatus 10 according to the third embodiment includes the inquiry unit 206. The inquiry unit 206, in a case where it is determined that the information necessary for execution of the one design task is not included in the design information of the one design task, automatically generates a question related to the one design task and transmits the question to a predetermined inquiry destination. The inquiry unit 206 automatically generates the question by using a large language model. The inquiry unit 206 may select an inquiry destination from among destinations described in an expert database. By the operation of the inquiry unit 206, efficient communication among stakeholders is realized in a complex system development environment.

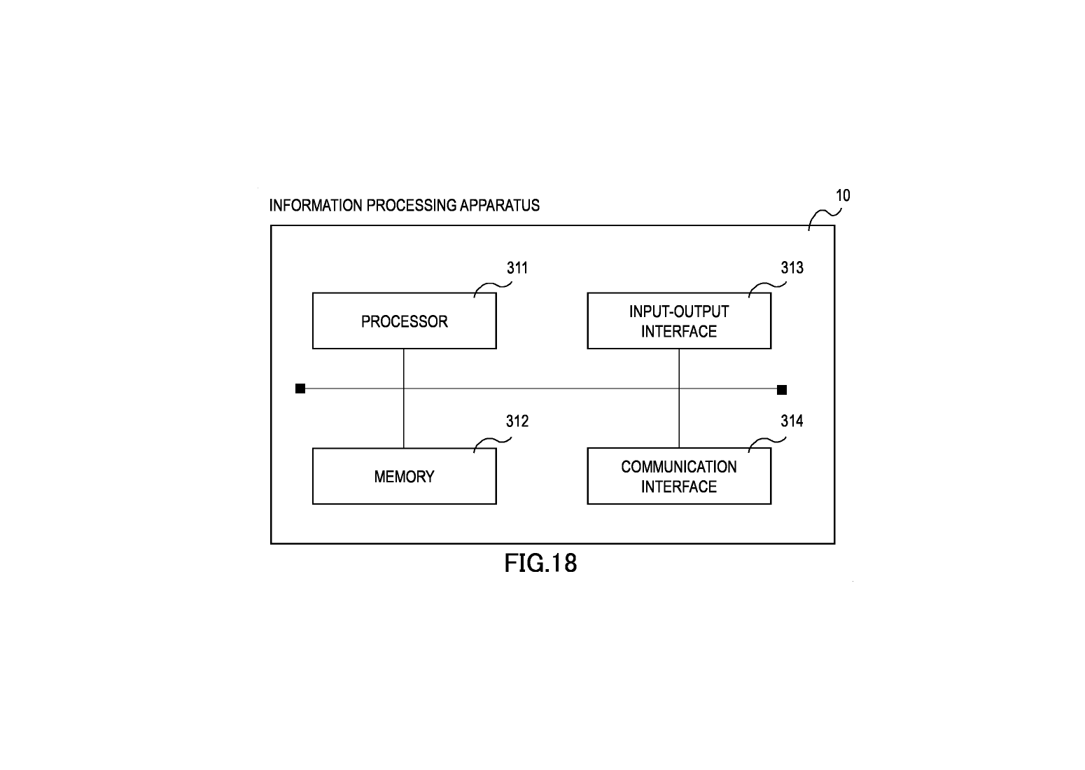

Next, a hardware configuration of an individual apparatus that constitutes the information processing system will be described. FIG. 18 is a diagram illustrating an example of a hardware configuration of the information processing apparatus 10.

The information processing apparatus 10 is able to be configured by an information processing apparatus (a so-called computer) and has a configuration illustrated as an example in FIG. 18. For example, the information processing apparatus 10 includes a processor 311, a memory 312, an input-output interface 313, and a communication interface 314 or the like. The above-described components such as the processor 311 are connected via an internal bus or the like and are configured to be capable of communicating with each other.

However, the configuration shown in FIG. 18 is not intended to limit the hardware configuration of the information processing apparatus 10. The information processing apparatus 10 may include hardware not illustrated or may be configured without the input-output interface 313 if desired. In addition, the number of components, such as the number of processors 311, included in the information processing apparatus 10 is not limited to the example illustrated in FIG. 18. For example, a plurality of processors 311 may be included in the information processing apparatus 10.

The processor 311 is a programmable device such as a CPU (Central Processing Unit), an MPU (Micro Processing Unit), a DSP (Digital Signal Processor), a TPU (Tensor Processing Unit), a GPU (Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus that are not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like that performs communication with other apparatuses. For example, the communication interface 314 includes a NIC (Network Interface Card) or the like.

The functions of the information processing apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the terminal 20 is also able to be configured by an information processing apparatus similar to the information processing apparatus 10, and since its basic hardware configuration has no difference from the information processing apparatus 10, description thereof will be omitted.

The information processing apparatus 10 includes a computer, and functions of the information processing apparatus 10 are able to be realized by causing the computer to execute a program. In addition, the information processing apparatus 10 executes a control method of the information processing apparatus 10 and an information processing method by means of the program.

### Variations

It should be noted that the configuration, operation, and so on of the information processing system described in the above embodiment are examples, and are not intended to limit the configuration and so on of the system.

In the above embodiments, the case where the information processing apparatus 10 is realized as a server in a server-client system has been described as an example. However, the information processing apparatus 10 may be realized by the terminal 20 of a user in which a predetermined application is installed.

In the above embodiment, the case where a database is configured inside the information processing apparatus 10 has been described, but the database may be constructed in an external database server or the like. That is, some of the functions of the information processing apparatus 10 may be implemented in another apparatus. More specifically, the "satisfaction determination unit (satisfaction determination means)" or the like, described above, can be implemented in any of the apparatuses included in the system.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system or the like that supports system design performed by a user.

### Supplementary Note 1

An information processing apparatus including: an acquisition means that acquires at least information related to requirements for a system or restrictions on the system from a database that stores information related to the system; and a satisfaction determination means that determines, based on the acquired information related to requirements for the system or restrictions on the system, whether or not information necessary for execution of one design task among a plurality of design tasks in a phased design flow of the system is included in design information of the one design task.

### Supplementary Note 2

The information processing apparatus according to supplementary note 1, further including a retroactive determination means that determines whether or not input information, the input information being information inputted in accordance with a case where it is determined that the information necessary for execution of the one design task is not included in the design information of the one design task, affects a design result of an upper task of the one design task, and proposes, in a case where the input information affects the design result of the upper task, retroactive modification to the upper task.

### Supplementary Note 3

The information processing apparatus according to supplementary note 1 or 2, wherein the satisfaction determination means calculate a degree of satisfaction indicating a degree to which a design element described in the design information of the one design task satisfies the requirements for the system or the restrictions on the system, using a predetermined rule or a machine learning model.

### Supplementary Note 4

The information processing apparatus according to supplementary note 1 or 2, further including an inquiry means that generates automatically, in a case where it is determined that the information necessary for execution of the one design task is not included in the design information of the one design task, a question related to the one design task and transmits the question to a predetermined inquiry destination.

### Supplementary Note 5

The information processing apparatus according to supplementary note 4, wherein the inquiry means generates automatically the question by using a large language model.

### Supplementary Note 6

The information processing apparatus according to supplementary note 4, wherein the inquiry means selects the inquiry destination from among destinations described in an expert database.

### Supplementary Note 7

The information processing apparatus according to supplementary note 1 or 2, wherein the satisfaction determination means adjusts a criterion used for determining whether or not the information necessary for execution of the one design task is included in the design information of the one design task in accordance with whether waterfall development or agile development is adopted.

### Supplementary Note 8

An information processing method of an information processing apparatus, the information processing method including: acquiring at least information related to requirements for a system or restrictions on the system from a database that stores information related to the system; and determining, based on the acquired information related to requirements for the system or restrictions on the system, whether or not information necessary for execution of one design task among a plurality of design tasks in a phased design flow of the system is included in design information of the one design task.

### Supplementary Note 9

A program causing a computer mounted on an information processing apparatus to perform processing for: acquiring at least information related to requirements for a system or restrictions on the system from a database that stores information related to the system; and determining, based on the acquired information related to requirements for the system or restrictions on the system, whether or not information necessary for execution of one design task among a plurality of design tasks in a phased design flow of the system is included in design information of the one design task.

Furthermore, a part or all of the configurations described in supplementary notes 2 to 7, which are dependent on supplementary note 1, are able to also be dependent on supplementary notes 8 and 9 in accordance with the same dependent relationship as supplementary notes 2 to 7. Furthermore, not only supplementary notes 1, 8, and 9 but also, within a scope not departing from each of the above-described example embodiments, a part or all of the configurations described as supplementary notes are able to be similarly made dependent on various hardware, software, various recording means for recording software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus comprising:
at least one memory storing a set of instructions; and
at least one processor configured to execute the set of instructions to:
acquire at least information related to requirements for a system or restrictions on the system from a database that stores information related to the system; and
determine, based on the acquired information related to requirements for the system or restrictions on the system, whether or not information necessary for execution of one design task among a plurality of design tasks in a phased design flow of the system is included in design information of the one design task.

2. The information processing apparatus according to claim 1, wherein
the at least one processor is further configured to execute the set of instructions to:
determine whether or not input information, the input information being information inputted in accordance with a case where it is determined that the information necessary for execution of the one design task is not included in the design information of the one design task, affects a design result of an upper task of the one design task; and propose, in a case where the input information affects the design result of the upper task, retroactive modification to the upper task.

3. The information processing apparatus according to claim 1, wherein
the at least one processor is further configured to execute the set of instructions to calculate a degree of satisfaction indicating a degree to which a design element described in the design information of the one design task satisfies the requirements for the system or the restrictions on the system, using a predetermined rule or a machine learning model.

4. The information processing apparatus according to claim 1, wherein
the at least one processor is further configured to execute the set of instructions to:
generate automatically, in a case where it is determined that the information necessary for execution of the one design task is not included in the design information of the one design task, a question related to the one design task; and
transmit the question to a predetermined inquiry destination.

5. The information processing apparatus according to claim 4, wherein
the at least one processor is further configured to execute the set of instructions to generate automatically the question by using a large language model.

6. The information processing apparatus according to claim 4, wherein
the at least one processor is further configured to execute the set of instructions to select the inquiry destination from among destinations described in an expert database.

7. The information processing apparatus according to claim 1, wherein
the at least one processor is further configured to execute the set of instructions to adjust a criterion used for determining whether or not the information necessary for execution of the one design task is included in the design information of the one design task in accordance with whether waterfall development or agile development is adopted.

8. An information processing method of an information processing apparatus, the information processing method comprising:
acquiring at least information related to requirements for a system or restrictions on the system from a database that stores information related to the system; and
determining, based on the acquired information related to requirements for the system or restrictions on the system, whether or not information necessary for execution of one design task among a plurality of design tasks in a phased design flow of the system is included in design information of the one design task.

9. The information processing method according to claim 8, further comprising:
determining whether or not input information, the input information being information inputted in accordance with a case where it is determined that the information necessary for execution of the one design task is not included in the design information of the one design task, affects a design result of an upper task of the one design task; and proposing, in a case where the input information affects the design result of the upper task, retroactive modification to the upper task.

10. The information processing method according to claim 8, further comprising calculating a degree of satisfaction indicating a degree to which a design element described in the design information of the one design task satisfies the requirements for the system or the restrictions on the system, using a predetermined rule or a machine learning model.

11. The information processing method according to claim 8, further comprising:
generating automatically, in a case where it is determined that the information necessary for execution of the one design task is not included in the design information of the one design task, a question related to the one design task; and
transmitting the question to a predetermined inquiry destination.

12. The information processing method according to claim 11, further comprising generating automatically the question by using a large language model.

13. The information processing method according to claim 11, further comprising selecting the inquiry destination from among destinations described in an expert database.

14. The information processing method according to claim 8, further comprising adjusting a criterion used for determining whether or not the information necessary for execution of the one design task is included in the design information of the one design task in accordance with whether waterfall development or agile development is adopted.

15. A non-transitory computer-readable storage medium storing a program causing a computer mounted on an information processing apparatus to perform processing for:
acquiring at least information related to requirements for a system or restrictions on the system from a database that stores information related to the system; and
determining, based on the acquired information related to requirements for the system or restrictions on the system, whether or not information necessary for execution of one design task among a plurality of design tasks in a phased design flow of the system is included in design information of the one design task.
